(19) United States
(12) Patent Application Publication
(10) Pub. No.: US 2011/0289118 A1
(43) Pub. Date: Nov. 24, 2011

(54) MAPPING DOCUMENTS TO A RELATIONAL DATABASE TABLE WITH A DOCUMENT POSITION COLUMN

(75) Inventors: Liang Chen, San Diego, CA (US); Nikita Shamgunov, Bellevue, WA (US); Philip A. Bernstein, Bellevue, WA (US); Michael Rys, Sammamish, WA (US); James F. Terwilliger, Redmond, WA (US); Peter Alan Carlin, Taipei (TW); Dragan Tomic, Belgrade (RS)

(73) Assignee: MICROSOFT CORPORATION, Redmond, WA (US)

(21) Appl. No.: 12/783,559

(22) Filed: May 20, 2010

(51) Int. Cl. G06F 17/30

(52) U.S. Cl. 707/803; 707/812; 707/E17.054; 707/E17.008

(57) ABSTRACT

Architecture that maps document data (e.g., XML-extended markup language) into columns of one table, thereby avoiding schema normalization problems through special data storage. Moreover, an algorithm is described that can translate a query (e.g., in XPath (XML path language), a query language for navigating through document elements and attributes of an XML document) into a relational algebra query of the document column representation. Based on the characteristics of the new mapping, query rewriting rules are provided that optimize the relational algebra query by minimizing the number of joins. The mapping of XML documents to the table is based on a summary structure and a hierarchical labeling scheme (e.g., ordpath) to enable a high-fidelity representation. Annotations are employed on the summary structure nodes to assist in mapping XML elements and attributes to the table.

### BACKGROUND

Markup language processing for documents such as for XML (extensible markup language) continues to be important in commercial database systems. Many systems build XML databases on top of underlying relational engines and evaluate XML queries through SQL (structured query language) and XQuery queries. Although progress has been made in the academic community, most of the work concentrates on ideal cases, making that work hard to be deployed in real commercial engines. A problem is how to store an XML document in a relational database.

Mapping nested elements into flattened tables is an issue for the XML databases built on relational engines. Existing decompositions have been proposed, where the main focus is decomposing nested structure into normalized schemas. One approach captures parent-child edges by primary key/foreign key relationships between relational tables. A second approach uses a modified Dewey encoding to represent elements in XML. Hierarchical relationships and document order are implicitly captured by comparing two Dewey Id's (analogous to Dewey decimal classification systems for libraries). While normalized decompositions achieve storage efficiency, such decompositions shred XML documents into a large number of tuples over many tables. As a consequence, evaluating XML queries typically involves a large number of joins. Furthermore, most existing work focuses on ideal data format: the schema is predefined, relatively small (though recursion may exist) and stable, XML documents always conform to the schema, etc.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a novel mapping technique that maps document data (e.g., XML-extended markup language) into columns in one table. Storing XML document data in columns solves existing issues while avoiding schema normalization problems through special data storage. Moreover, an algorithm is described that can translate a query (e.g., XPath (XML path language) or XQuery, query languages for navigating through document elements and attributes of an XML document) into a relational algebra query of the document column representation. Based on the characteristics of the new mapping, query rewriting rules are provided that optimize the relational algebra query by minimizing the number of joins.

The documents are shredded into rows of a relational table based on metadata obtained from a summary structure (e.g., a data guide) that summarizes the structure of all documents. The table is flexible in that it can be extended according to the changes in the summary structure. When a summary structure node is added/deleted, the corresponding column(s) are added/removed as well. If the table is declared as having sparse columns, specific techniques (e.g., interpreted storage, i.e., attribute-value store) are used for the column storage, and thus modification is only required for rows that have actually changed. On the other hand, if the table is declared as a normal dense table, the column update may require modifications on all TOWS.

A query processing algorithm translates queries over the documents into relational algebra queries over the shredded representation in the relational database. The mapping of XML documents to the table is based on the data guide and a hierarchical labeling scheme, such as a modified Dewey encoding, to enable a high-fidelity representation. For example, ORDPATH (also “ordpath”) is a modified Dewey encoding that encodes the location of a node in a tree as the ordpath of the node's parent concatenated with an indication of the location of the node within the sequence of children of its parent. Additionally, annotations are employed on the data guide nodes to assist in mapping XML elements and attributes to the table.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a data processing system in accordance with the disclosed architecture.

FIG. 2 illustrates an alternative data processing system in accordance with the disclosed architecture.

FIG. 3 illustrates a flow block diagram that processes XML documents for storage into columns in an optimized way.

FIG. 4 illustrates more details of the query component of FIG. 2.

FIG. 5 illustrates a flow diagram that begins with an XML document and ends with a document having path information.

FIG. 6 illustrates table generation based on the annotated ordpath summary structure of FIG. 5.

FIG. 7 illustrates an annotated summary structure augmented with annotations and aliases.

FIG. 8 illustrates a high level representation of the translation framework.

FIG. 9 illustrates a fragment of a table.

FIG. 10 illustrates a data fragment for a query and matched pattern.

FIG. 11 illustrates an algebra tree for a query.

FIG. 12 illustrates a computer-implemented data processing method in accordance with the disclosed architecture.

FIG. 13 illustrates further aspects of the method of FIG. 12.

FIG. 14 illustrates an alternative data processing method.

FIG. 15 illustrates further aspects of the method of FIG. 14.

FIG. 16 illustrates a block diagram of a computing system that executes the mapping of documents to columns of a relational database in accordance with the disclosed architecture.

### DETAILED DESCRIPTION

In relational database servers, XML (extensible markup language) can defined as a data type of a column, and XML documents are inserted as cells in tuples. When the column is declared (e.g., by an administrator), the schema may not be known in advance, since the data is coming from external sources. Second, with no schema predefined, the schema may be summarized from an existing document corpus, and then used for normalization. However, the summarized schema evolves dynamically when new documents are inserted or old documents are deleted, which results in expensive schema evolution. Third, even if there is a predefined schema, new incoming XML documents may not be consistent with the schema. Moreover, maintaining the inconsistent documents rather than discarding such documents is, in many cases, highly desirable. These issues make the existing work difficult, if not impossible, to be deployed in the real commercial systems.

The disclosed architecture maps XML documents into columns of a table. Unlike existing work that aims to achieve the normalized schema, the disclosed mapping takes the other extreme and maps all the elements to a single table. Storing all the elements in one table avoids the need for schema normalization and provides more flexibility in supporting a wide range of XML documents without the above constraints. Given the new mapping, it is shown that XPath (XML path language) and XQuery can be evaluated over the columns. Moreover, a translation optimization framework is provided that leverages the characteristics of the new mapping to minimize the number of joins.

Documents are shredded into rows of a relational table based on metadata obtained from a summary structure (also denoted herein as a data guide) that summarizes the structure of all documents. The table can be quite wide given the number of possible columns generated and the intent is to minimize the joins by then minimizing the number of table rows employed. The mapping of the document into a table uses an ordpath column plus a summary structure to derive enough information to identify the document location of all populated elements of each row (and to do it in a way that minimizes the number of rows needed to represent the document).

A query processing algorithm translates queries (e.g., XPath, a query language for navigating through document elements and attributes of an XML document) over the documents into relational algebra queries over the shredded representation in the relational database. Query optimization rules use information in the summary structure to reduce the number of joins otherwise needed to process many queries. A hierarchical labeling scheme (e.g., ORDPATH (herein “ordpath”)) is employed to enable a high-fidelity representation. Annotations are employed on the summary structure nodes to assist in mapping XML elements and attributes to the table.

The ordpath technique utilized herein is a modified version that uses the summary structure. The ordpath of a node E in a document is the ordpath OPp of E's parent P concatenated with one or two positive integers, either M or M.N. Thus, E's ordpath is either OP_{P}/M or OP_{P}/M.N.
If E is the only instance of its corresponding node D in the summary structure, then M is the index of D among D's siblings in the summary structure. That is, if D is the first child of its parent in the summary structure, then M=1; if it's the second child, then M=2; and so forth.
If E is one of many instances of its corresponding node D in the summary structure, then it is assigned M.N, where M is the index of D among its siblings in the summary structure and N is the index of E among its D-siblings of its parent P. That is, if D is the first child of its parent in the summary structure, and E is the third D-child of P, then E is assigned 1.3. If D is the second child of its parent in the summary structure, and E is the first D-child of P, then E is assigned 2.1.

The same numbering scheme can be used to assign an ordpath to each node in the summary structure. However, since each label can appear only once as a child of its parent, the case of M.N does not arise.

For each node in the summary structure, one or more columns are created in the table, either an element column C or an attribute column A, depending on whether it is an element node or attribute node. That is, if it is known that a summary structure node has exactly three instances in every document, then three columns can be generated for the node, to avoid a join to reassemble the document. In addition, if it's an element column C and one or more documents has text content for its C element, then a text element column C-text is created in the table. Each column is associated with the ordpath of the summary structure node that corresponds to the column.

Each XML document is stored in one or more rows of this table. A goal is to store the document in the minimal number of rows, so as to answer queries over the document using the fewest number of joins. The mapping can be the following. Choose a node in the document whose parent (if it has one) is stored in the table. Initially, the only choice is the root. Store the root R in the row by setting its C column to 1 and its C-text to the content of the root (if it has content). For each child of R that is the only instance of its corresponding summary structure node, set its C column in the row to 1 and store its C-text value if appropriate. If there is a sequence of children of R that all correspond to the same summary structure node, set the associated column to 1, which effectively stores the first child (only) in the row, plus store its C-text value if appropriate. (The other children will be mapped to other rows as the process iterates over unmapped document nodes.) The ordpath column of the row is the longest common prefix of the ordpaths of all the nodes in the row. Continue with another node N of the document such that N's parent is already stored, but N is not yet stored in the table. If N is the only instance of its corresponding summary structure node or is the first sibling of a sequence of consecutive siblings that all correspond to the same summary structure node, then it is stored in the same row as its parent. Otherwise, a new row is created for N plus all of its descendants that can be stored in the row according to the above rules.

An algorithm is provided to translate each XML document into rows that populate the table, according to the above scheme. When mapping XML documents to the table, “exception nodes” are employed to capture the exact order of document nodes. The exception nodes handle cases where the order enforced in the summary structure violates the document order of some XML instances.

An algorithm for processing a query expression (e.g., in XPath) translates the expression into relational algebra. The algorithm processes each component of the expression, where a component is the subexpression that precedes the first slash (if any), a subexpression in between two consecutive slashes, or the subexpression following the last slash (if any). Generally, the translation algorithm works as follows. The translation algorithm starts by translating the first component of the query expression into a relational algebraic expression, followed by iterations over the remaining components. For each slash encountered, the algorithm joins the previous expression that has been built so far with an expression that represents the next component. The join condition depends on the axis that the slash is traveling. The algorithm then projects the result on the docid column (the next step continues with the same doc) and the ordpath column (so the next step continues traversing the document at the point that the expression-so-far has left off).

The algorithm can be considered a case statement for traversal over each of the axes (e.g., child, parent, preceding, following, etc.), plus selections to handle predicates (e.g., bracketed expressions), functions to handle aggregations, the use of the rank( ) function to handle XPath position( ) and last( ) and custom functions to handle functions over node sets.

A query translator generates a join for each component of the query expression. However, in many cases, the summary structure can be used to determine that the rows to be joined are actually in the same row, so the join is useless. These cases are detected through a combination of careful naming of table variables and rewriting rules.

All table variables range over the one and only table used to represent the XML documents. Each node in the summary structure is given an associated table variable. If a node has either no annotation or an annotation of “?”, then the node is assigned the same table variable as its parent. The reason is that instances of the child are stored in the same row as its parent—never on different rows—and therefore a join is not needed to traverse that parent-child relationship. The translator described above uses these table variables in the expressions generated.

Rewriting rules take advantage of this careful assignment of table variables. Some of the rules are generic, in the sense that no special knowledge of XPath is required. For example, consider the expression selectₚ(T₁) [symbol] select_{Q}(T₁), where T₁ is a table variable, the join is an equi-join, and P and Q are predicates. The only time that equi-join is generated by the translator is when the join is on docid and ordpath, which together constitute a key. Thus, this expression can be rewritten as select_{P&Q}(T₁). Other rules are defined, some of which do exploit knowledge of XPath, the table design, and summary structure annotations.

The architecture is described in three parts: mapping an XML document into rows of a table, translating a query into a relational algebra query over the column representation of the document, and query rewriting rules that optimize the relational algebra query by reducing or eliminating the number joins.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

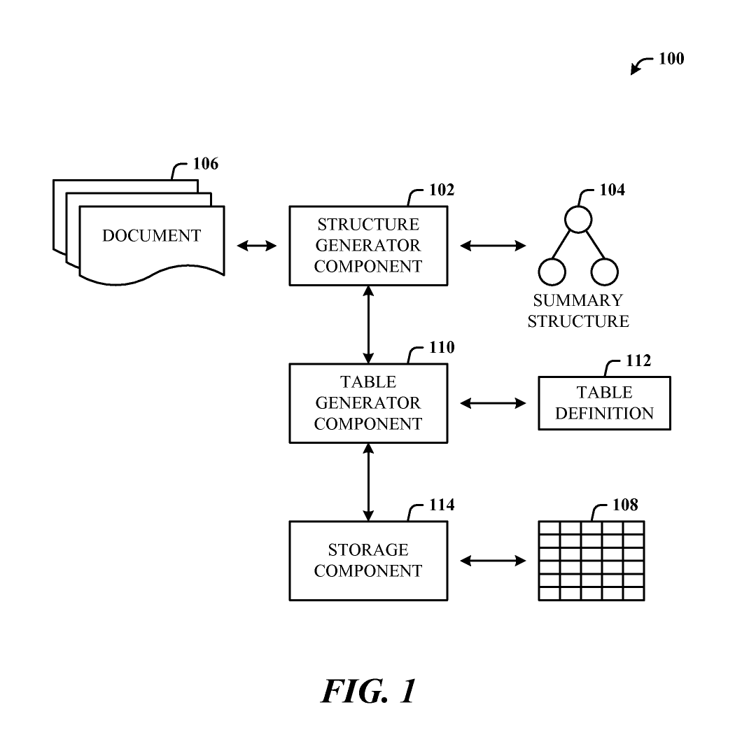

FIG. 1 illustrates a data processing system 100 in accordance with the disclosed architecture. The system 100 includes a structure generator component 102 that generates a summary structure 104 based on documents 106 to be stored in a table 108.

A sparse table can be employed, which is a wide uni-dimensional table. The sparse table is a good representation, particularly when there is type diversity among the XML documents being stored.

The summary structure 104 includes nodes for labels in the documents 106 and path information to positions of the nodes in the documents 106. A table generator component 110 generates a table definition 112 based on the summary structure 104 and creates the table 108 (e.g., sparse) according to the table definition 112. Each node of the summary structure 104 maps to one or more columns of the table 108. Additionally, one column of the table contains a document-position column that identifies one position in a document such that for each row, the document-position, summary structure and schema structure include suitable information to derive the document location of all populated elements of the row. A storage component 114 maps the nodes and path information into the table 108 according to the table definition 112.

The documents 106 can be XML documents. Generally, the structure generator component generates the summary structure based on the schema information about the documents (e.g., XML Schema Definition using any XML schema language (e.g., DTD (document type definition), XML schema, Relax NG (Regular Language for XML Next Generation), etc.)). The structure generator component 102 annotates the summary structure 104 to indicate instances of child nodes relative to a parent. The table 108 includes columns for at least one of a document identifier, the path information, element column for each node of the summary structure, text element column for each element node that has text content, or attribute column for each attribute node of the summary structure 104. The storage component 114 translates each of the documents 106 into rows of the table 108. The summary structure 104 includes exception nodes that track order of the nodes in the documents 106.

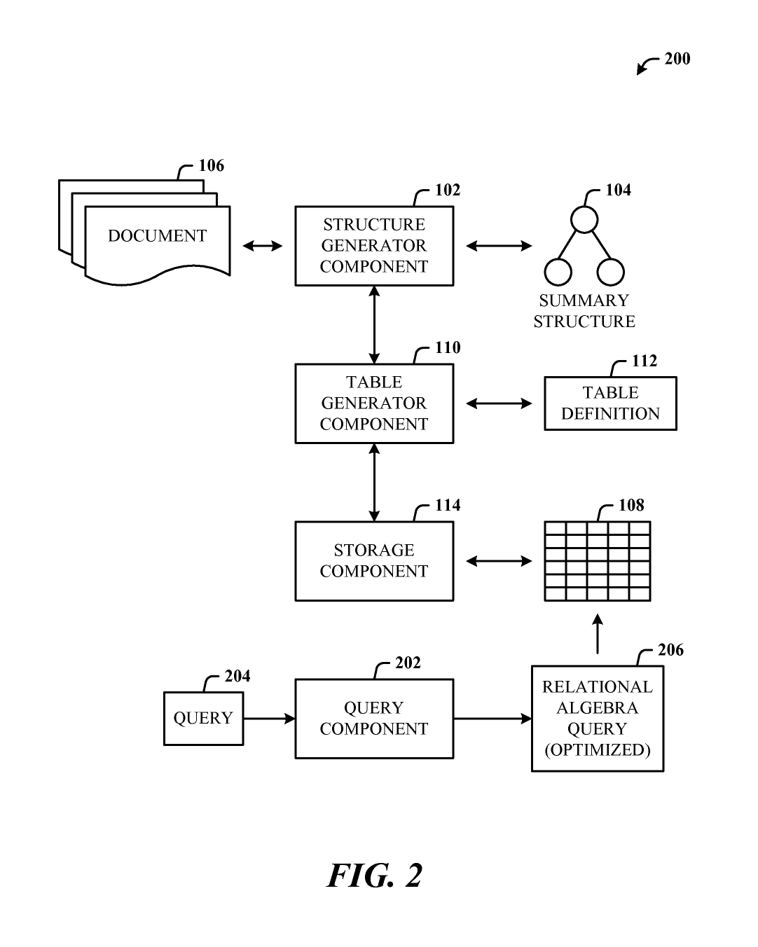

FIG. 2 illustrates an alternative data processing system 200 in accordance with the disclosed architecture. The system 200 includes the structure generator component 102, table generator component 110, and storage component 114 of the system 100 of FIG. 1, and further comprises a query component 202 that translates a query 204 over documents (e.g., XML) into a relational algebra query 206 over the columns of the table 108. The query component 202 rewrites the relational algebra query 206 based on table variables assigned to nodes of the summary structure 104. The query component 202 further optimizes the query 204 by eliminating join operators based on at least one of the table variables, predicates, or summary structure used in the query.

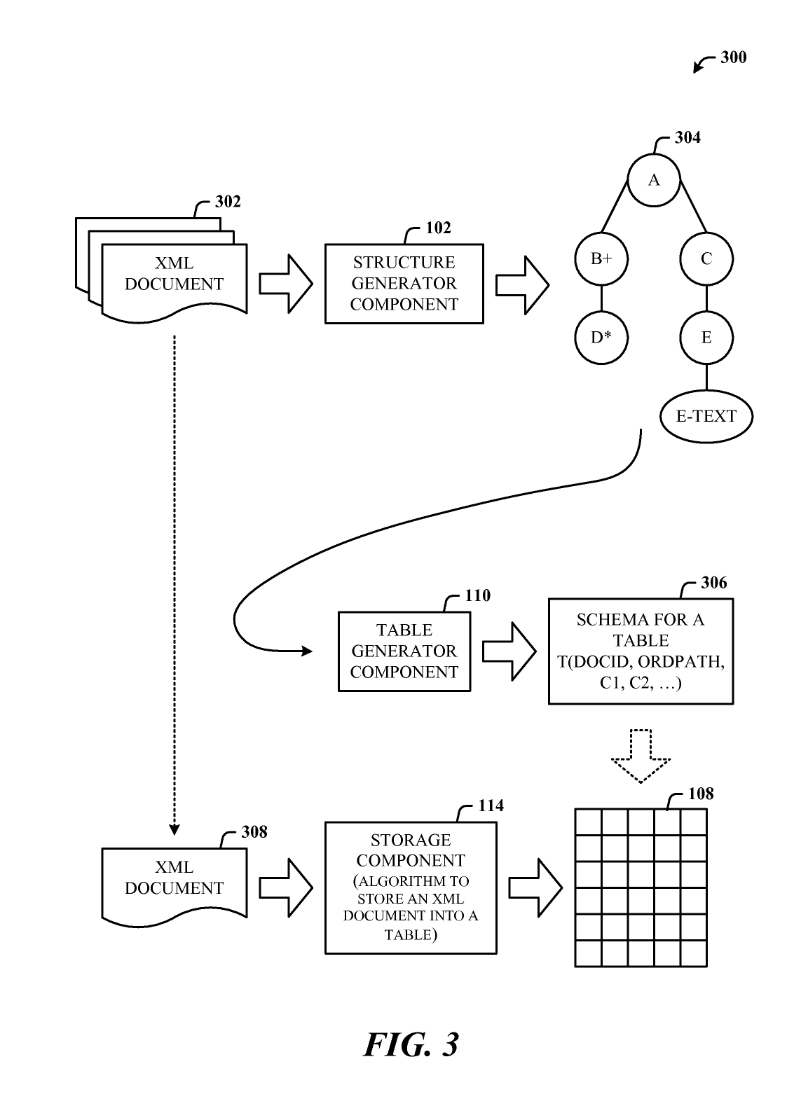

FIG. 3 illustrates a flow block diagram 300 that processes XML documents for storage into columns in an optimized way. The diagram 300 begins with receiving XML documents 302 (e.g., the documents 106), which are then processed through the structure generator component 102 into an annotated summary structure 304. Based on the annotated summary structure 304, the table generator component 110 outputs a schema 306 (e.g., table definition 112) that defines table structure and content of the table 108. For example, as described in detail herein, the table 108 can include document identifier, path information (e.g., via ordpath), element columns, attribute columns, and text element columns. Once the table structure is defined by the schema 306, an XML document 308 (of the documents 302) is input to the storage component 114 to store the document 308 into the table 108.

The summary structure 304 can be constructed by a sequential scan of the XML documents 302. Each new document is scanned root-to-leaf. For each of its elements and attributes, if there is no corresponding node in the summary structure, then a node is added.

As indicated herein, the summary structure 304 is augmented with annotations that indicate how many instances of a summary structure node can appear under its parent node in a document. This is reflected in a rewriting rule described below. The node's annotation is “?” if it's optional, “+” if it must have at least one instance, and “*” if it can have any number of instances. If a node has no annotation then it must appear exactly once underneath its parent.

The summary structure is used to create the table definition 112 (or schema 306) for the documents to be stored. The table has the following columns:
docid—the unique id of an XML document. Many rows may be needed to represent the document. The docid column is what ties the rows together.
ordpath—a path of numbers that defines the exact position of a node in an XML document. A modified version of the ordpaths is employed herein.
C—a Boolean-valued “element column”, one for each node in the summary structure.
C-text—a string-valued “text-element column”, one for each element node in the summary structure that has text content in at least one document.
A—a string-valued “attribute column”, one for each attribute node in the summary structure.

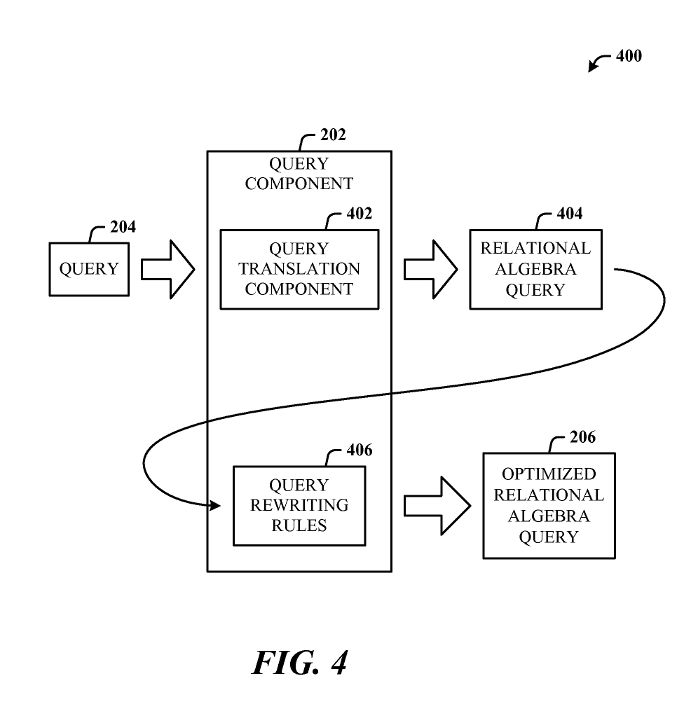

FIG. 4 illustrates more details of the query component 202 of FIG. 2. The query component 202 includes a query translation component 402 that receives the query 202 and translates the query into a relational algebra query 404 over the columns of the table. The query component 202 rewrites the relational algebra query 404 based on table variables (and query rewriting rules 406) assigned to nodes of the summary structure. The rewritten query 404 is the optimized relational algebra query 206 that includes a reduced number of joins (an aggregation operator), which otherwise would be employed to process such query expressions in conventional systems, based on the table variables.

Following is a detailed description of the architecture for mapping XML documents to columns in a relational database.

The mapping of a document (e.g., XML) to a relational table (table 108) is based on schema information (e.g., schema 306) expressed in the summary structure. The summary structure is a labeled tree that contains information about the labels and relative location of the labels in a set of XML documents. Thus, the summary structure can be loosely referred to herein as a schema.

Each of the nodes in the summary structure is a label that appears in a document element or a document attribute of a document to be stored. For each element E in a document, there is a node N in the summary structure, such that the sequence of element labels from the document root to element E is the same as the sequence of node labels from the root of the summary structure to N. Document attributes are handled similarly, as children of the element in which the children are embedded. Thus, the summary structure summarizes all paths through the document.

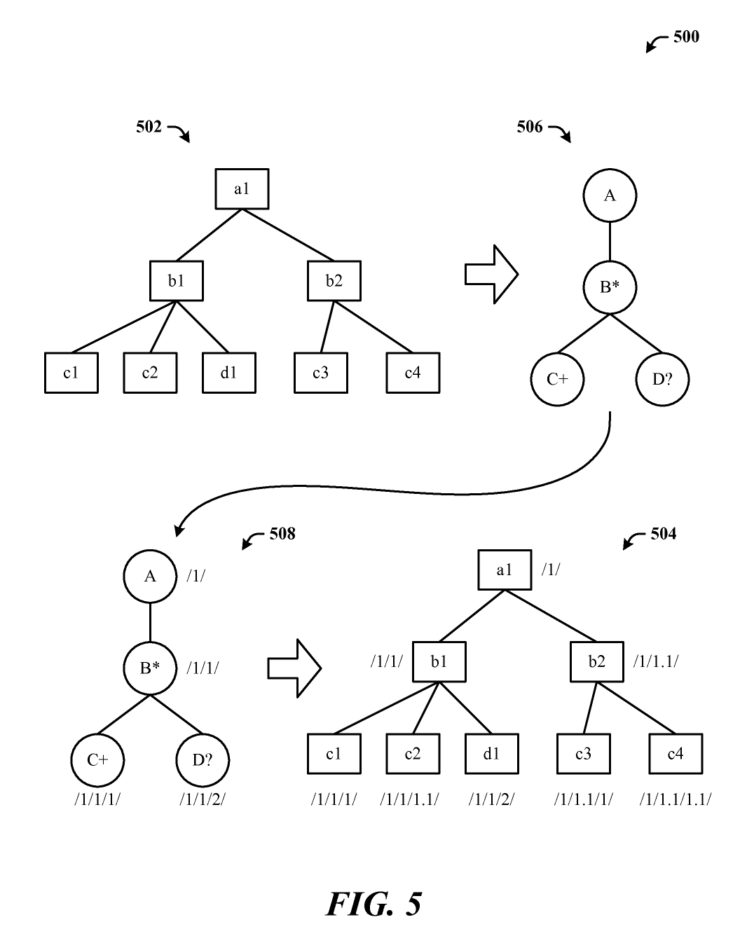

FIG. 5 illustrates a flow diagram 500 that begins with an XML document 502 and ends with a document 504 having path information (ordpath). A summary structure 506 of the XML document summarizes all the paths in the document instance. Basically, all the nodes that have the same root-to-node path are mapped into one node in the summary structure 506, so that all distinct label paths appear exactly once. The summary structure 506 is shown, where capitalized characters denote nodes in the summary structure 506 and small characters (e.g., a1, b1, etc.) denote elements in the XML document. Since multiple instances of the same document-label-path collapse into one path in the summary structure 506, the size of the summary structure 506 is normally much smaller than the document, though theoretically it can be as large as the document.

The summary structure of a document only captures the hierarchical tree structure, but not the element positions in the document. To this end, each element in the document is assigned path information (referred to hereinafter as ordpath), which is conceptually similar to the Dewey encoding of library systems, but provides efficient insertion and compression. Given the ordpaths of all the elements, the whole XML tree can be reconstructed. Thus, all the elements of the summary structure 506 are annotated with assigned ordpaths, as shown in the annotated ordpath summary structure 508.

In contrast to encoding elements in the XML document directly, nodes in the summary structure are assigned ordpaths first, as shown in the annotated ordpath summary structure 508. These ordpaths are called base ordpaths.

Ordpaths assigned to an XML element ν is confined by the base ordpaths in the following way:

1. An element ordpath is its parent ordpath plus the component assigned to element ν, where the component is the index of the element within the sequence of its siblings.

2. For collection nodes (consecutive siblings with the same element label), the first element's component is the same as the corresponding summary structure node. All the following elements in the collection fall in the range between the current and the next summary structure node. In document 504, elements c1 and c2 are two collection nodes: c1 is the first element, and thus, its component is the same as C in the summary structure 506; c2 is the second element and its component falls within the range between 1 and 2, thus designated 1.1.

3. For non-collection nodes (the element label is unique among its siblings), its component is the same as the summary structure node to which it is mapped. In document 502, element d1 is a non-collection node and its component is the D node (i.e., 2).

In the traditional summary structure definition, there is no order among siblings. However, as used herein, an order is enforced among siblings by assigning ordpaths to the siblings. Ordpaths of the summary structure nodes are used as the “boundaries” to confine ordpath encoding of XML instances (documents). This scheme benefits storage efficiency.

In practice, it is possible that the order enforced in the summary structure violates the document order of some XML instances. For example, if there is another node c3 following node d1 as its sibling, though it is also mapped to C in the summary structure, the node c3 ordpath does not fall in the range between C and D. In such case, node c3 is called an exception node. In this case, node c3 's ordpath is still confined by the D node in the summary structure, that is, node c3 's ordpath should be greater than D, but less than D's next sibling (none shown). In general, ordpaths assigned to the summary structure introduce one possible order by which all the XML document ordpaths are bound.

With respect to mapping XML to table columns, given the summary structure of an XML corpus, each node of the summary structure is mapped to at least a column. XML elements are stored in the corresponding columns to which the elements are mapped. For an element ν, some of the element children are stored in the same row as element ν:

Mapping Rule 1: For the children that are non-collection elements, always store these children in the same row.

Mapping Rule 2: For the children that belong to a collection, only store the first element in the same row; store the other elements of the collection in separate rows.

Mapping Rule 3: The children that are exception nodes are stored in separate rows.

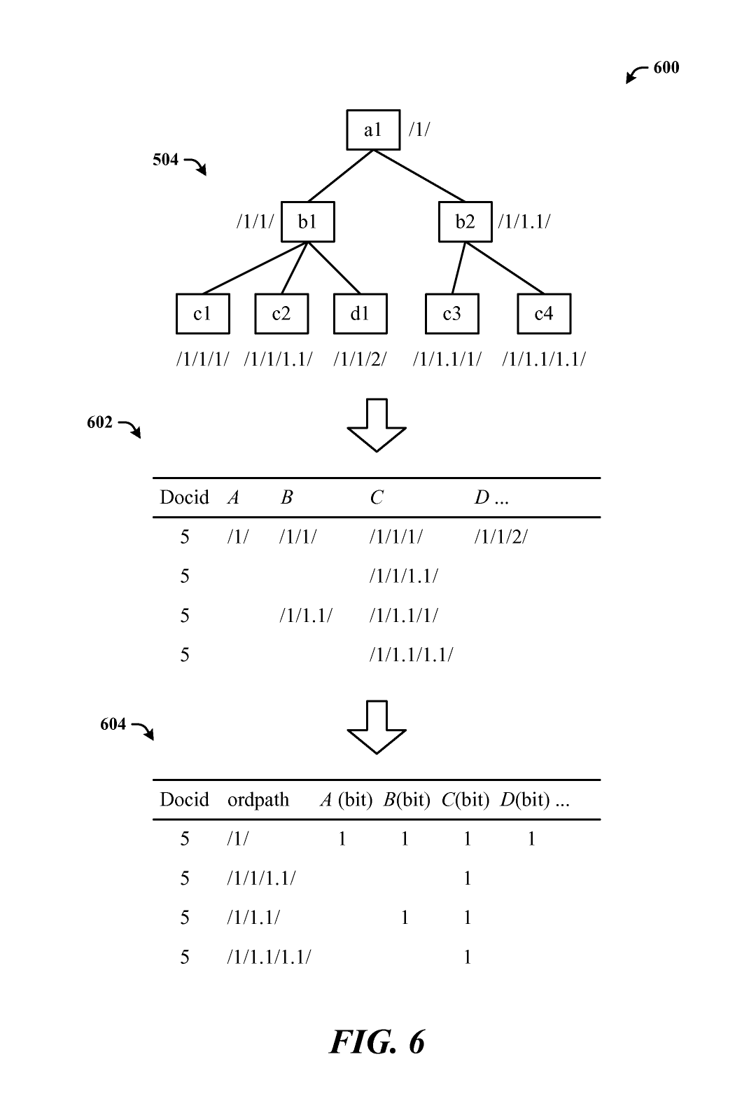

FIG. 6 illustrates table generation based on the annotated ordpath summary structure 508 of FIG. 5. Beginning with the ordpath document 504 of FIG. 5, a table 602 is created that shows the columns to which the XML document 504 is mapped. Elements b1, b2 are the two elements of collection B. Since b1 is the first element under a1, b1 is stored in the same row as a1, and b2 is stored in a different row. Recursively, since c1 is the first element in the collection C, c1 is stored in the same row as b1, and c2 is stored in a different row.

The columns can be compressed. For each row, only the ordpath that is the longest common prefix of all the ordpaths in that row is retained. All the other entries in the row are set to one bit. A new compressed table 604 is shown where the ordpath column is called the primary ordpath. The compressed table 604 stores only one primary ordpath in each row and thus improves storage efficiency. The ordpath of a non-null entry can be reconstructed by the primary ordpath of that row and the base ordpath to which that column is mapped.

Let realop (meaning “real ordpath”) be a function that calculates the real ordpath of an entry within a row. Given the primary ordpath of a row and summary structure, it is calculated as follows. If the length of the primary ordpath of a row is the same as the base ordpath of a column, then the primary ordpath is also the real ordpath of the entry in that column. Since the primary ordpath is the longest common prefix of all the real ordpaths in that row, no other entries could have ordpaths shorter than it. In fact, the element in this entry must be a non-first element in a collection or an exception element, or the document root.

Consider the column C in the second row (c2 for /1/1/1.1/) of the table 602. The primary ordpath is /1/1/1.1/. Since the base ordpath of the C node in the summary structure 508 of FIG. 5 is /1/1/1/, which has the same length as the primary ordpath, the primary ordpath /1/1/1.1/is also the real ordpath of c2 .

If the primary ordpath of a row is shorter than the base ordpath of the column, then the entry in this column must be the first element in a collection or a non-collection element. (Otherwise, according to the Mapping Rule, it should be stored in a separate row where the primary ordpath is also the real ordpath.) Therefore, the component assigned to this element is also the last component of its base ordpath. The real ordpath of this element is the real ordpath of its parent plus its component, where its parent's real ordpath can be derived recursively.

Consider the column D in the first row (d1 for /1/1/2/) in the table 602. Its base ordpath in the summary structure is /1/1/2/which is longer than the primary ordpath of the first row. The component assigned to this element must be the last component of /1/1/2/, which is 2. The parent of the d element must be in the same row which turns out to be the first element in a collection (the B collection). This process keeps tracing d's ancestors until some ancestor's real ordpath can be derived directly.

Algorithmically, this process can be summarized as a single operation: given d1 's base ordpath ord_{b}=/1/1/2/and its primary ordpath ordₚ=/1/, d1 's real ordpath is ordₚ∥suffix(ord_{b}, |ordₚ|) where ∥ denotes the concatenation and suffix(ord_{b}, ∥ordₚ|) denotes the suffix of ord_{b} without the first |ordₚ| components. In this case, suffix(ord_{b}, |ordₚ|) is the last two components of ord_{b}, i.e., 1/2/.

The base ordpaths assigned to the summary structure act as fixed boundaries for all the XML instances, making the derivation easy for all the rows. For comparison, mapping ordpath encodings without summary structure confinement is also possible. However, no compression is available for this table. In this case the component assigned to d1 is not fixed and determined by the number of elements in the C collection, so replacing its real ordpath by a bit would result in expensive real ordpath reconstruction.

Following is a detailed description of translating a query into a relational query over a document's representation in a table using the above techniques. For purposes of this description, the query is an XPath query and the relational query can be a SQL query.

With respect to initial notation, let T denote the table to which an XML corpus is mapped. Without loss of generality, assume the table is not compressed, so its entries represent the ordpath directly. Let e denote an XPath expression that returns a value of one of the four types, namely node set, number, string, or Boolean, which are represented by R(e), num(e), str(e), bool(e), respectively. Specifically, in the context of relational algebra, R(e) is a set of binary tuples [symbol] id, ord [symbol] , where id is the identifier of the XML document and ord is an ordpath. Each tuple in R(e) identifies an element returned by the expression e. Given an ordpath ord, GetAncestor(k) is a scalar function that computes the ordpath of the k-level higher ancestor of ord. Use ord.anc(k) as shorthand. For compactness, the rename operator ρ is allowed to be used in the projection list. For instance, π_{id,A→ord}(T) renames the projected attribute A to ord.

Base expression. Let e₀ be one of two base expressions: either a tag name A or the symbol *. The corresponding relational algebra expressions are:

R(A)=∪_{A}_{ᵢ}_{εA}(π_{id,A→ord}(σ_{A}_{ᵢ}_{≠null}T))

R(*)=∪_{X}(π_{id,X→ord}(σ_{X≠null}T))

where A is a set of columns whose tag names are A and X is any column in T.

XPath axes. XPath location paths are expressed as eχe₀, where χ is one of the axes, e is an XPath expression, and e₀ is one of the base expressions. Each axis corresponds to a relational algebra expression of the form:

π_{R(e}_{₀}_{).id,R(e}_{₀}_{).ord}(R(e) [symbol] _{C}_{_{χ}}R(e₀)

where C_{χ} is a join condition that is listed in the following Table 1.

The descendant-or-self (ancestor-or-self) axis is composed of itself and descendant (ancestor) axes, so its algebra expression is:

R(e)∪π_{R(e}_{₀}_{).id,R(e}_{₀}_{).ord}R(e) [symbol] _{C}_{_{χ}}R(e₀)

where χ is either descendant or ancestor.

TABLE 1
Join conditions of XPath axes

| χ | Join Condition Cₓ |
|---|---|
| e/child :: e₀ | R(e) · id = R(e₀) · id [symbol] R(e) · ord = R(e₀) · ord · anc(1) |
| e/parent :: e₀ | R(e) · id = R(e₀) · id [symbol] R(e) · ord · anc(1) = R(e₀) · ord |
| e/decendant :: e₀ | R(e) · id = R(e₀) · id [symbol] R(e) · ord is prefix of R(e₀) · ord |
| e/ancestor :: e₀ | R(e) · id = R(e₀) · id [symbol] R(e₀) · ord is prefix of R(e₀) · ord |
| e/following :: e₀ | R(e) · id = R(e₀) · id [symbol] R(e) · ord < R(e₀) · ord |
| e/preceding :: e₀ | R(e) · id = R(e₀) · id [symbol] R(e) · ord > R(e₀) · ord |
| e/following - sibling :: e₀ | R(e) · id = R(e₀) · id [symbol] R(e) · ord < R(e₀) · ord |
| | [symbol] R(e) · ord · anc(1) = R(e₀) · ord · anc(1) |
| e/proceeding - sibling :: e₀ | R(e) · id = R(e₀) · id [symbol] R(e) · ord > R(e₀) · ord |
| | [symbol] R(e) · ord · anc(1) = R(e₀) · ord · anc(1) |

Predicates. A predicate filters a node set with respect to a predicate expression pe, which also returns a value of one of the four types. Consider the expression e[pe]:

1. if pe returns a node set, without loss of generality, assume pe is one or more relative location paths that start from the projection node of e. The algebra expression R(pe) is the same as R(e) except that R(pe) also projects the starting node. For example, for the expression /A[./B/C], R(pe)=R(A) [symbol] R(B) [symbol] R(C) and projects R(A).ord. The algebra expression for e[pe] is π_{R(e).id,R(e).ord}(R(e) [symbol] R(pe)). Notice that semi-join ( [symbol] ) is used, as e[pe] does not project any node within pe.

2. if pe returns a Boolean value, pe can be viewed as a function such that for each tuple t in R(e), pe(t) returns a Boolean value. Thus, the algebra expression of e[pe] is π_{R(e).id,R(e).ord}(σ_{pe(tεR(e))=true}R(e)). XPath includes four types of functions: node set functions, string functions, Boolean functions and number functions. Functions that do not contain a node set as input or output are trivial in algebra. In the following only those functions that involve a node set are summarized.

Let num denote a numeric value, str denote a string value, bool denote a Boolean value, and RelOp ε{=, ≠, ≦, <, ≧, >}. For the node set R(e), use R(e).val to denote string values of nodes in the set: if the node is an element, val is its tag name; if the node is a text node, val is the content of the text; if the node is an attribute, val is the attribute value. For simplicity, val is omitted from the previous algebra expressions. It is trivial to add val to the selection if the XPath query uses a function that requires it.

Aggregation. Function count(e) returns the number of nodes in a node set. Its algebra expression is: G_{count}(R(e)).

Position operator. Function position( ) returns the position of the input node within its context. Unfortunately, though ordpath captures the document order, it does not record the position directly. Moreover, the conventional relational algebra operators only manipulate sets of tuples, which have no order. Still it can be defined by a relational algebraic operator that corresponds to operations that are available in many relational database systems. For example, the rank( ) function in T-SQL (Transaction SQL) can be used to rank the inputs and give the tuple positions in the sorted list, which can reconstruct the position functions. Combining a relational algebraic operator for the group-by operator with a rank function, the relational algebraic expression to calculate position( ) in the XPath expression “position( )[eχe₀]” is:

_{R(e).ord}G_{rank(R(e}_{₀}_{).ord)}(R(e) [symbol] R(e₀))

where G is the grouping operator and rank( ) gives the tuple's position in each group. The left subscript of G defines the group-by column, that is, the set of rows with the same value of this column. The right subscript is the function to apply to each set defined by the left subscript, where the rows are sorted by increasing value of ord. The expression returns a set of triples <id, ord, rk> where id and ord identify the element and rk is the rank of the element according to the above expression. The third component of the triple is eliminated depending on how the position( ) function is used. For example, the translation of an XPath expression eχe₀[position( )=7] is:

eχe₀[position( )=7]=π_{id,ord}(σᵣₖ₌₇(_{R(e).ord}G_{rank(R(e}_{₀}_{).ord)→rk}(R(e) [symbol] R(e₀))))

Similarly, the function last( ) returns the position of the last input node within its context, that is:

eχe₀[last( )]=_{R(e).ord}G_{count(R(e}_{₀}_{).ord)}(R(e) [symbol] R(e₀))

Other functions. The following Table 2 lists other functions that have node set. For similar functions, only one of the functions is listed.

TABLE 2
Other operators in XPath

| Operator | Semantics | Relational algebra |
|---|---|---|
| F[sum: nset | Σ_{n∈R(e)}to_num(n) | Gₛᵤₘ(πₜₒ_num(val)R(e)) |
| → num](R(e)) | | |
| F[sum: nset | | G_{cancatenate}_str(π₍ᵥₐₗ₎R(e)) |
| → str](R(e)) | | |
| F[id: str → nset](str) | deref_ids(str) | ∪_{I}(π_{id, realop(I)}(σ_{I=str}T)) |
| | | where I are the columns |
| | | corresponding to those ID |
| | | attribute nodes in the DG |
| F[id: nset | | ∪_{r∈R(e)}F[id](r · val) |
| → nset](R(e)) | | |
| F[RelOp: nset × nset | ∃n₁ ∈ R(e₁), n₂ ∈ R(e₂): | R(e₁) [symbol] _{C} R(e₂) where C: |
| → bool](R(e₁), R(e₂)) | str(n₁) RelOp str(n₂) | R(e₁) · id = R(e₂) · id |
| | | [symbol] R(e₁) · val RelOp R(e₂) · val |
| F[RelOp: nset × num | | σ_{val RelOp ν}(R(e)) |
| → bool](R(e₁), ν) | | |

The disclosed architecture also provides translation optimization by minimizing the number of joins. Full XPath can be evaluated over the table by translating XPath to SQL. However, the general translation discussed so far is not optimal: each axis in the query requires one self-join of the table. Given the characteristics of the new mapping, the number of self-joins can be significantly reduced. Specifically, two opportunities are identified:

1. The summary structure summarizes hierarchical relationships of all the XML instances. Comparing the query to the summary structure narrows down the possible result space and avoids expending effort on all of the instances. For example, consider the path /A//B. If nodes B₁, B₂ in the summary structure satisfy the path expression (the tag name of a common ancestor of B₁ and B₂ is A), then the node set can be calculated without doing a join using this relational algebra query:

π_{id,B1→ord}(σ_{B1≠null}(T₁))∪π_{id,B2→ord}(σ_{B2≠null}(T₂))

In general, the summary structure can be used as a summary to pre-compute part of the query and identify columns and data of interest with fewer (if any) joins.

2. The mapping stores all of the non-collection children of a node in the same row, which may further reduce the number of joins. Consider the query /A[/B]/C. Given that for all XML instances, a, b and c nodes are always stored in the same row, the query evaluation is simply a selection on the table, that is:

π_{id,C→ord}(σ_{C≠nullΛB≠null}(T)).

It is beneficial to augment the summary structure definition with annotations that help guide the optimizations introduced later. Nodes in the summary structure are mapped to columns in a single table. If each summary structure node occurs at most once in all of the XML instances, then nodes of each XML instance fit into a single row and query evaluation is simply a selection on the table.

A self-join arises when a summary structure node appears multiple times in document(s) so that these elements span multiple rows. For example, the query /A/B associates b elements with a elements through an axis. A join is needed if a has multiple b children. On the other hand, if a and b are always in the same row, the join can be eliminated.

When the XPath query is translated into SQL, such information needs to be known in advance to determine whether a join is necessary. To this end, each node in the summary structure is annotated by one of the following keywords, indicating the number of occurrences of this summary structure node under its parent in the XML corpus.

1. *: zero or more.

2. +: at least one.

3. ?: zero or one.

4. If there is no *, + or ?, then there is exactly one occurrence.

The annotations are assigned when the summary structure is generated from the corpus. When new documents are imported and shredded over the summary structure, the corresponding summary structure nodes are also updated.

In addition to the annotation, each summary structure node is assigned an alias of T with an integer subscript such that,

1. if the node is the root, then assign T₁ to that node.

2. if the node is annotated with the symbol * or +, then assign a new alias to that node.

3. otherwise, assign its parent's alias to the node.

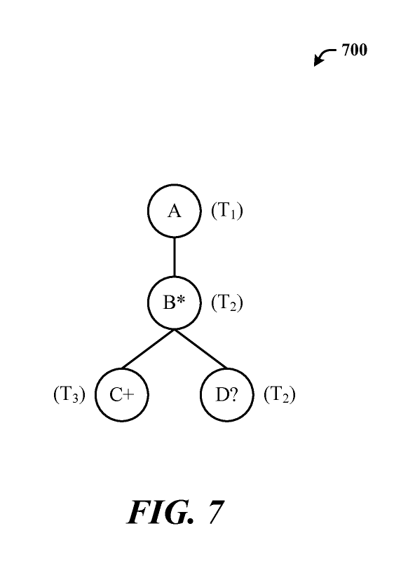

FIG. 7 illustrates an annotated summary structure 700 augmented with annotations and aliases. Alias numbers are useful to track one-to-many relationships between an ancestor and its descendants, which are used in the optimization stage to infer if a join can be simplified or not.

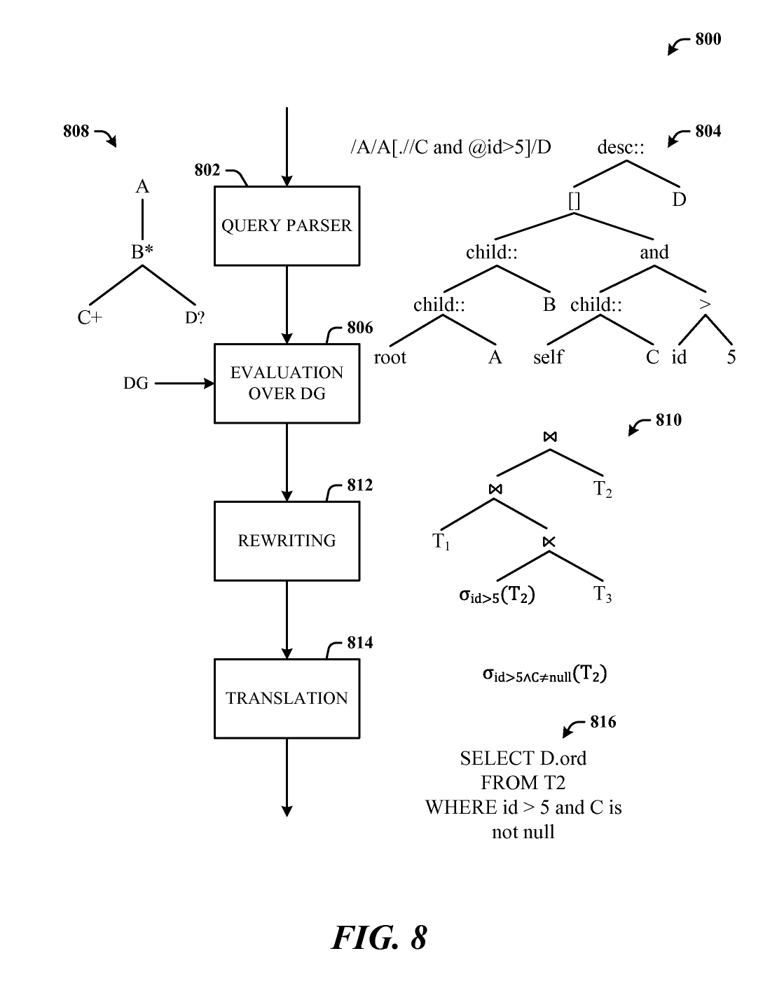

FIG. 8 illustrates a high level representation of the translation framework 800. First, a query parser 802 receives an XPath query (e.g., query 204) as input and parses the query into a tree 804. An evaluation module 806 evaluates the parsed tree 804 over a summary structure 808, and generates an algebra tree 810 following the translation rules described above. As described previously, the summary structure summarizes hierarchical relationships in all the XML documents. Therefore, XPath axes can be evaluated over the summary structure first, which matches those columns that potentially satisfy the query. Consider the query /A/*. Naive translation requires a join between column A and the union of all the other columns, that is, T(A) [symbol] (T(B)∪T(C)∪ . . . ). Evaluation using the summary structure only keeps those columns that appear as A's children in the summary structure.

When the query is matched over the summary structure, hierarchical axes can be evaluated precisely (e.g., child, descendant, etc.). However, since the order between the summary structure nodes is enforced, the guide may not fully reflect the actual order in the XML documents. For those axes related to the document order (e.g., following-siblings), to guarantee the correctness of the translation, all the summary structure nodes that might satisfy the condition are included in the algebra. For example, consider the query //C/ following-sibling::* over the aliased annotated summary structure 700 of FIG. 7. While D is the following sibling of C in the summary structure, the C node is annotated by “+”, which means that multiple c nodes may appear as siblings in an XML document. Therefore, in the translated algebra, a join is needed between a row containing column C and another row containing either another C-value or a D-value in the same document.

Furthermore, exception nodes violate the order of the summary structure nodes and their positions in documents are not predictable through the summary structure. Consequently, the exception nodes should be considered as well. In the above example, if there is another node E that precedes C in the summary structure and some exception nodes are mapped to it, column E should also be included in the join expression. To enable the query translator to recognize whether such a join is needed, when XML documents are shredded over the summary structure, an additional Boolean annotation is added to each summary structure node, indicating whether exception nodes are mapped to it or not.

Given the algebra tree 810, a rewriting module 812 rewrites the algebra tree 810 based on a set of rules. Generally, annotations and alias names are used as hints to infer if a join can be eliminated or simplified to a selection. The simplified algebra tree is then translated by translation 814 into a SQL query 816.

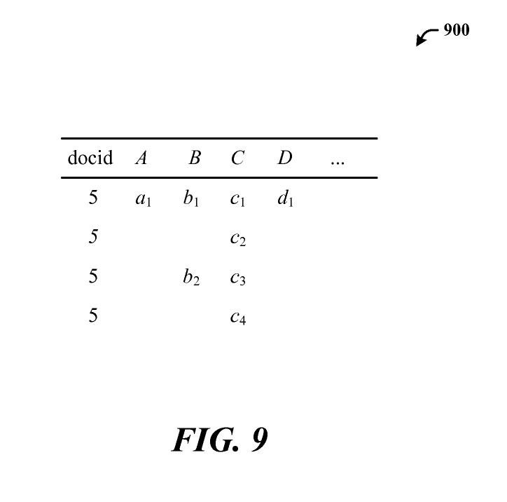

Following is a description of the rewriting rules to minimize the number of joins. The basic idea is using the information gathered from the documents (e.g., the annotations in the summary structure) to simplify a join into selections. FIG. 9 illustrates a fragment of a table 900.

Rewriting Rule 1. σₛ₁(T₁) [symbol] σₛ₂(T₁)→σ_{s1Λs2}(T₁), if the join is an equi-join and s₂ does not contain a position predicate. s₁ and s₂ are the selection conditions of the two relations. Equi join corresponds to the hierarchical axes in XPath (e.g., child, descendant, parent, etc.). In the above description, each node of the summary structure 808 is assigned an alias, which tracks one-to-many relationships in the XML documents. Within one XML document, nodes in the columns that share the same alias are always in the same row. Therefore, the above join can be simplified by merging the selection conditions. In XPath, position evaluation requires context nodes. When T₂ contains position predicate, T₁ specifies the context node and therefore the join cannot be simplified.

Rewriting Rule 2. σₛ₁(T₁) [symbol] σₛ₂(T₂)→σₛ₂(T₂), if the join is an equi-join and S₁ is a single “not-null” selection condition and s₂ does not contain a position predicate. XPath axes only project on the target node. For example, for the query A/B, there is a selection condition on T₁ that A is not null. When there is no predicate on A, all the nodes in the column B satisfy the query and thus are projected. Therefore, the above join can be eliminated. On the other hand, if there is a predicate on A, for example, A[@id=5]/B, in table 900, then a₁ may be filtered out. A b node in column B must also be filtered out if it is in a row that joins with the row containing a₁. In such a case, a join is required to associate nodes in the column B with satisfied a nodes.

Rewriting Rule 3. σₛ₁(T₁) [symbol] σₛ₂(T₁)→σ_{s1Λs2}(T₁), if the semi join is an equi-semi-join and s₂ does not contain a position predicate. Semi-join corresponds to the path expression within a predicate, for example, /A[./B]. Similar to Rewriting Rule 1, the semi join can also be simplified by merging the selections.

Rewriting Rule 4. σₛ₁(T₁) [symbol] σₛ₂(T₂)→σ_{s1Λs2}(T₁),if

1. the semi-join is an equi-semi-join.

2. s₂ is a single not-null selection condition.

3. No “+” or “*” is followed by * or ? in the path from A to B in the summary structure, where A and B are two projection columns of the two input relations.

The semantics of the path expression within a predicate is “existence”. That is, as long as one such path exists, the context node survives. In the translation, if it is guaranteed that nodes in T₁ can always be joined with nodes in T₂, the join can be eliminated. For example, consider the query A[./B]. B is annotated by * in FIG. 7 (zero or more b nodes under an a node). According to Mapping Rule 2 above, as long as the B collection has at least one node, some b node must appear in the same row as a. Therefore, the join can be simplified to a selection σ_{A≠nullΛB≠null}(T₁).

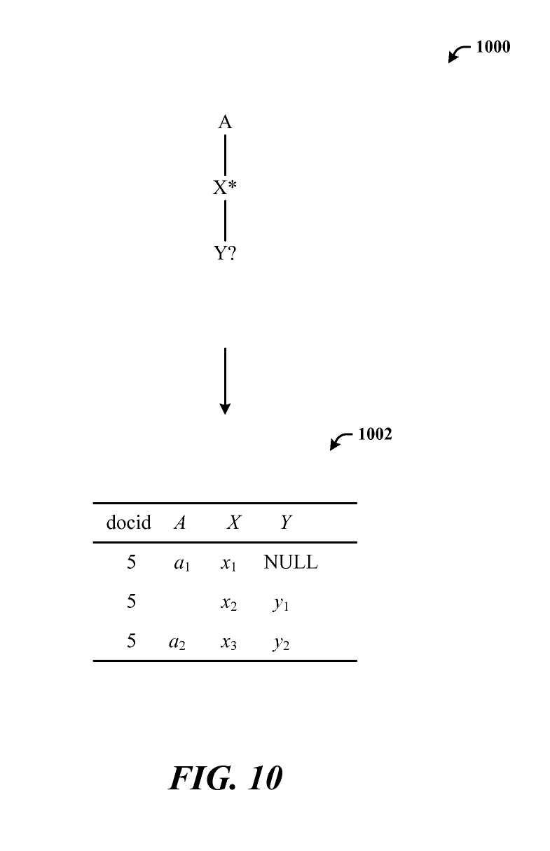

Such a property is transitive only within nodes annotated by + or none. Consider the query A[.//Y] and the matched pattern shown in the data fragment 1000 of FIG. 10. Table 1002 shows a table fragment. Note that y₁ is not in the same row as x₁, though it is still a descendant of a₁. More formally, if one of the symbols “*” or “?” follows a symbol “*” or “+” (not necessarily consecutively) in a path of the summary structure, such a path can exist in the XML document and the two endpoints of the path may not appear in the same row.

Similar to Rewriting Rule 2, if T₂ contains additional selection conditions (e.g., @id=1), the b node that is in the same row as a may be filtered out. The process is to associate a with other surviving b nodes that reside in different rows, and the join cannot be simplified.

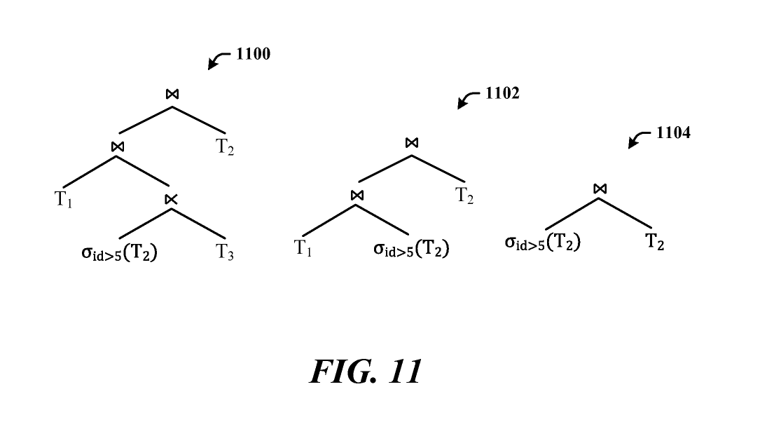

In an example, consider the XPath query /A/B[./C and @id>5]/D over the summary structure 700 of FIG. 7. The original algebra tree 1100 of the query is shown in FIG. 11. The semi-join σ_{id>5} (T₂) [symbol] T₃ is rewritten first using Rewriting Rule 4. Since the input relations correspond to B and C in the summary structure and there is no * or ? between them, this semi-join can be eliminated, as shown in next algebra tree 1102. The join T₁ [symbol] T₂ in tree 1102 is further simplified by Rewriting Rule 2. Finally, the join expression in the last tree 1104 is simplified into a single selection by Rewriting Rule 1.

With respect to rewriting queries using an index, an index on one or more columns supports both rapid random lookups and efficient access of ordered records. For a table with columns, the index is called a filtered index. Since there is only one table in the new mapping, an index on one column may also provide fast access for another column.

Consider a selection on one column (e.g., π_{bid,ord}(σ_{A≠null} (T))), which is a frequent operation in the translated algebra expressions. If there is no index on column A, the selection requires a full scan of the table. If the table has an index on column B and from the summary structure it is known that a and b nodes are always in the same row of the table, rewriting the query into π_{bid,ord}(σ_{A≠nullΛB≠null}(T)) utilizes the index on B to first filter out unrelated rows and avoid a full scan of the table. In general, summary structure nodes with the same assigned alias can use the same filtered index for column selection.

With respect to physical join execution optimization, when the table is compressed and entries are represented by bits, the scalar functions realop( ) and GetAncestor( ) are needed to reconstruct the real ordpath in order to perform joins. Since realop( ) and GetAncestor( ) are user-defined functions, the relational engine has no knowledge thereof and therefore is incapable of choosing the right join plan. An observation is that a clustered index is built on primary ordpath. Therefore, the real ordpaths in each column are also sorted automatically. Specifically, the following properties exist.

Property 6.1

π_{id,realop(A)}(σ_{A≠null}(T)) is ordered by the two projected attributes.

The proof is as follows. Consider two nodes a₁ and a₂ in column A within a document. The primary ordpath of these two rows are either the real ordpath or not.

1. At least one of their primary ordpaths is the real ordpath. This is because a₁ and a₂ belong to the same collection. Only one of a₁ and a₂ may appear in the same row as its parent.

2. If the primary ordpaths of the two rows are both the real ordpaths of a₁ and a₂, then a₁ and a₂ are already sorted by the clustered index.

3. If a₁'s primary ordpath is not its real ordpath, but a₂'s is, then a₁'s primary ordpath must be shorter than a₂. In the clustered index, a₁'s primary ordpath must precede a₂'s ordpath.

This property is not valid upon updates if the following is satisfied: if the first element in a collection changes, the new first element must appear in the same row as its parent, which may trigger updates on the whole subtree rooted at the changed element.

Property 6.2

Given an XPath expression e and its algebra expression R(e), if R(e) is ordered by id and ord, then π_{id,ord.anc(k)}(R(e)) is also ordered.

The above properties imply that a selection on the table always generates an ordered tuple set. A join operator can be evaluated by merge join without additional sorting.

The mapping from documents to tables that is described herein can be implemented in several different components of a database system. In one embodiment, it is implemented in a mid-tier component (outside the database system) that stores the tables and executes the queries. The mid-tier component creates the summary structure, issues operations to define a table structure and create a table based on the table structure, translates queries over documents into queries over the table, optimizes queries over tables, sends each optimized query to the database system, and processes the response to each query.

In a second embodiment, the mapping is implemented inside the database system. A first table is created with a document-valued column, and each document is stored in a row of the table as a value of that column. In addition, the content of each document is stored in a second table based on the mapping techniques described herein. The database system hides the second table from users of the database system. The system treats the second table as an index over the document column of the former table. The database system translates each query on the document column into an optimized query on the second table. This translation can benefit from efficient structures inside the database system for manipulating data stored in an index.

In a third embodiment, the database system uses the multi-column table as a primary storage structure for documents. Like an index, this table structure is hidden from users of the database system—the users see only a document-valued column against which queries can be posed. As in the second embodiment, the database system translates each query on documents into an optimized query on the table. This translation can benefit from efficient structures inside the database system that are only available to query operations that execute against primary storage structures.

In other words, the structure generator component, table generator component, and storage component can be part of a mid-tier component that stores tables and executes queries. Alternatively, or in combination therewith, the structure generator component, table generator component, and storage component can be employed to create an index over a document-valued column of a table. Still further, the structure generator component, table generator component, and storage component can be a primary storage system for a document-valued column.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

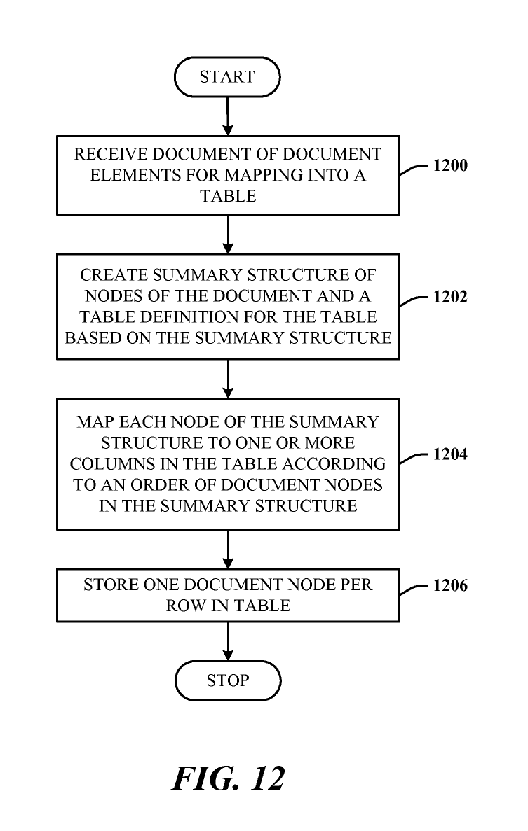

FIG. 12 illustrates a computer-implemented data processing method in accordance with the disclosed architecture. At 1200, document of document elements is received for mapping into a table. At 1202, a summary structure of nodes of the document is created and a table definition for the table based on the summary structure is created. At 1204, each node of the summary structure is mapped to one or more columns in the table according to an order of document nodes in the summary structure. At 1206, a document node is stored one node per row in the table.

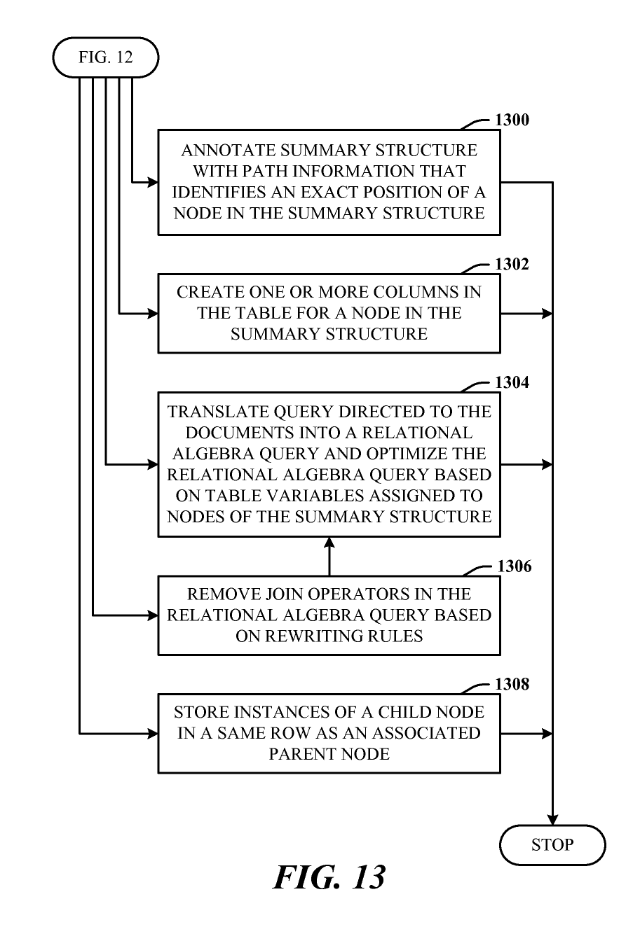

FIG. 13 illustrates further aspects of the method of FIG. 12. Note that the arrowing indicates that each block represents a step that can be included, separately or in combination with other blocks, as additional steps of the method represented by the flow chart of FIG. 12. At 1300, the summary structure is annotated with path information that identifies an exact position of a node in the summary structure. At 1302, at least one column is created in the table for a node in the summary structure. At 1304, a query directed to the documents is translated into a relational algebra query and the relational algebra query is optimized based on table variables assigned to nodes of the summary structure. At 1306, join operators in the relational algebra query are removed based on rewriting rules. At 1308, instances of a child node are stored in a same row as an associated parent node.

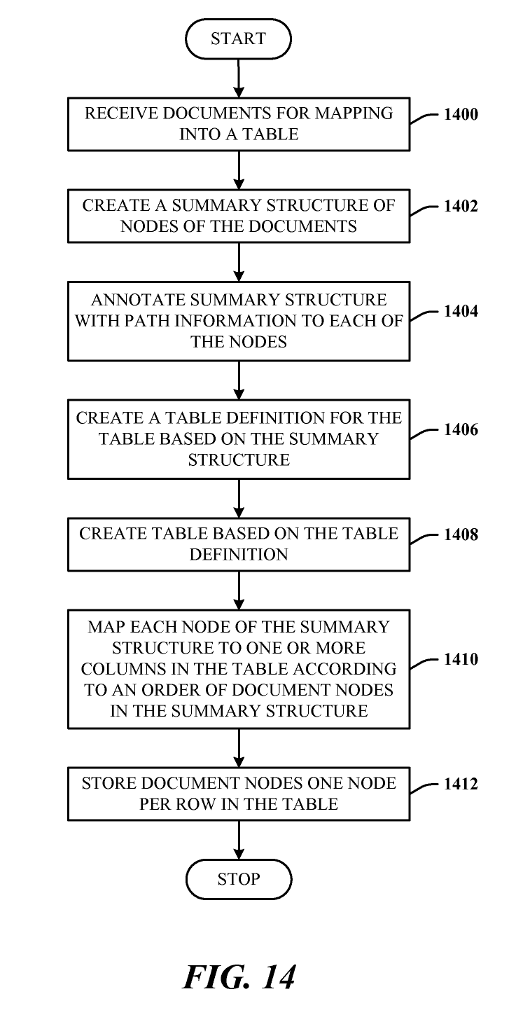

FIG. 14 illustrates an alternative data processing method. At 1400, documents are received for mapping into a table. At 1402, a summary structure of nodes of the documents is created. At 1404, the summary structure is annotated with path information to each of the nodes. At 1406, a table definition is created for the table based on the summary structure. At 1408, the table is created based on the table definition. At 1410, each node of the summary structure is mapped to a respective column in the table according to an order of document nodes in the summary structure. At 1412, document nodes are stored in the table one node per row.

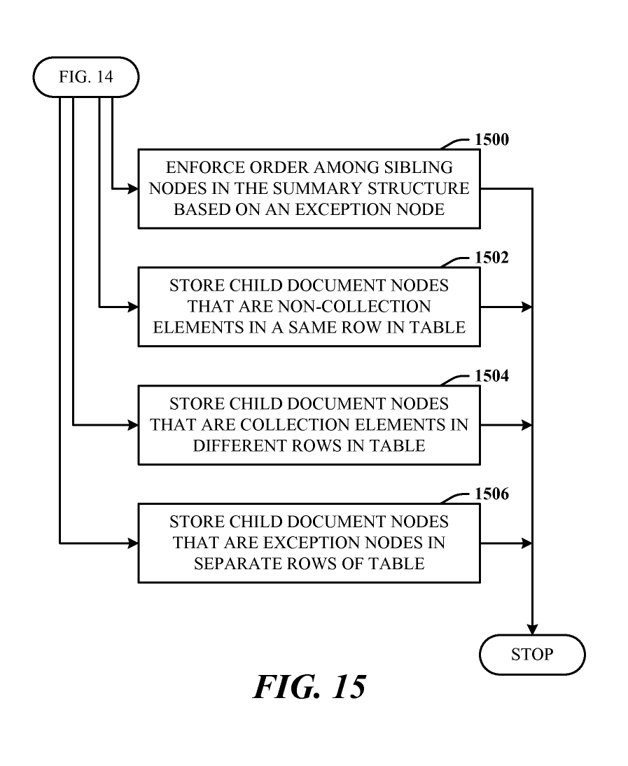

FIG. 15 illustrates further aspects of the method of FIG. 14. Note that the arrowing indicates that each block represents a step that can be included, separately or in combination with other blocks, as additional steps of method represented by the flow chart of FIG. 14. At 1500, order among sibling nodes in the summary structure is enforced based on an exception node. At 1502, child document nodes that are non-collection elements are stored in a same row in the table. At 1504, child document nodes that are collection elements are stored in different rows in the table. At 1506, child document nodes that are exception nodes are stored in separate rows of the table.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

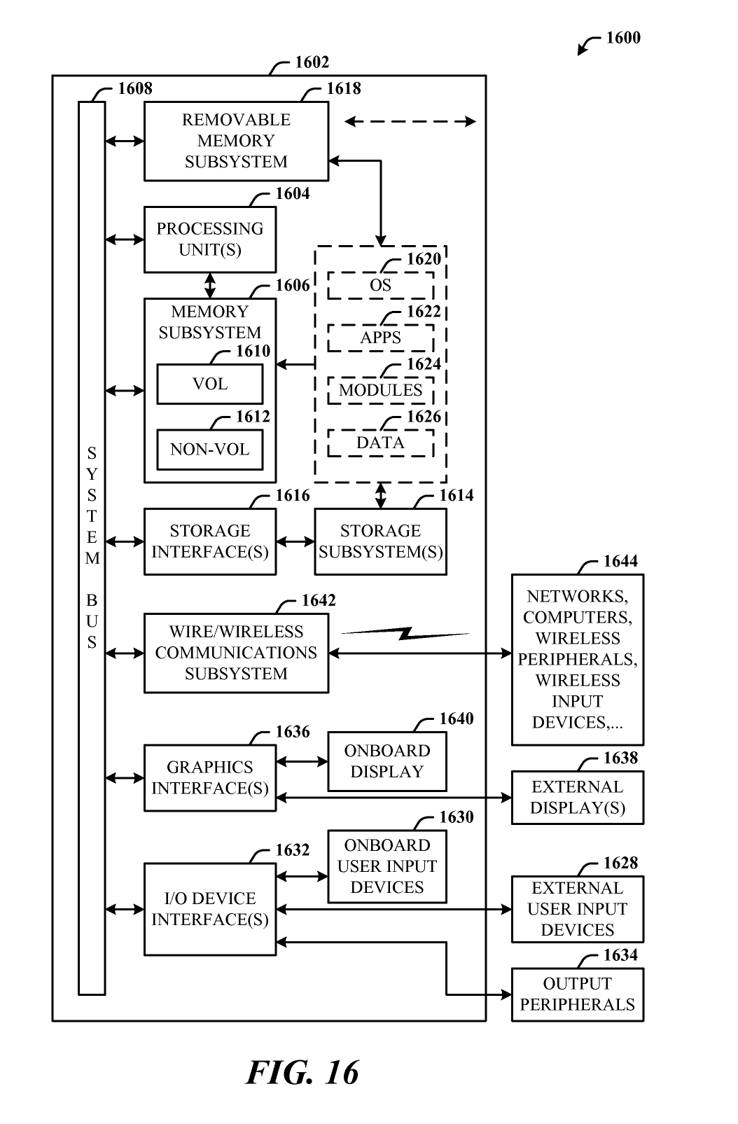

Referring now to FIG. 16, there is illustrated a block diagram of a computing system 1600 that executes the mapping of documents to columns of a relational database in accordance with the disclosed architecture. In order to provide additional context for various aspects thereof, FIG. 16 and the following description are intended to provide a brief, general description of the suitable computing system 1600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1600 for implementing various aspects includes the computer 1602 having processing unit(s) 1604, a computer-readable storage such as a system memory 1606, and a system bus 1608. The processing unit(s) 1604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1606 can include computer-readable storage (physical storage media) such as a volatile (VOL) memory 1610 (e.g., random access memory (RAM)) and non-volatile memory (NON-VOL) 1612 (e.g., ROM, EPROM, EEPROM, etc.). A basic input/output system (BIOS) can be stored in the non-volatile memory 1612, and includes the basic routines that facilitate the communication of data and signals between components within the computer 1602, such as during startup. The volatile memory 1610 can also include a high-speed RAM such as static RAM for caching data.

The system bus 1608 provides an interface for system components including, but not limited to, the system memory 1606 to the processing unit(s) 1604. The system bus 1608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1602 further includes machine readable storage subsystem(s) 1614 and storage interface(s) 1616 for interfacing the storage subsystem(s) 1614 to the system bus 1608 and other desired computer components. The storage subsystem(s) 1614 (physical storage media) can include one or more of a hard disk drive (HDD), a magnetic floppy disk drive (FDD), and/or optical disk storage drive (e.g., a CD-ROM drive DVD drive), for example. The storage interface(s) 1616 can include interface technologies such as EIDE, ATA, SATA, and IEEE 1394, for example.

One or more programs and data can be stored in the memory subsystem 1606, a machine readable and removable memory subsystem 1618 (e.g., flash drive form factor technology), and/or the storage subsystem(s) 1614 (e.g., optical, magnetic, solid state), including an operating system 1620, one or more application programs 1622, other program modules 1624, and program data 1626.

The one or more application programs 1622, other program modules 1624, and program data 1626 can include the entities and components of the system 100 of FIG. 1, the entities and components of the system 200 of FIG. 2, the entities and flow of the diagram 300 of FIG. 3, the entities and components of the query component of FIG. 4, flow diagram 500 of FIG. 5, the tree and tables of FIG. 6, the summary structure of FIG. 7, the translation framework of FIG. 8, the entities of FIGS. 9-11, and the methods represented by the flowcharts of FIGS. 12-15, for example.

Generally, programs include routines, methods, data structures, other software components, etc., that perform particular tasks or implement particular abstract data types. All or portions of the operating system 1620, applications 1622, modules 1624, and/or data 1626 can also be cached in memory such as the volatile memory 1610, for example. It is to be appreciated that the disclosed architecture can be implemented with various commercially available operating systems or combinations of operating systems (e.g., as virtual machines).

The storage subsystem(s) 1614 and memory subsystems (1606 and 1618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1602 and includes volatile and non-volatile internal and/or external media that is removable or non-removable. For the computer 1602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1602, programs, and data using external user input devices 1628 such as a keyboard and a mouse. Other external user input devices 1628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1602, programs, and data using onboard user input devices 1630 such a touchpad, microphone, keyboard, etc., where the computer 1602 is a portable computer, for example. These and other input devices are connected to the processing unit(s) 1604 through input/output (I/O) device interface(s) 1632 via the system bus 1608, but can be connected by other interfaces such as a parallel port, IEEE 1394 serial port, a game port, a USB port, an IR interface, etc. The I/O device interface(s) 1632 also facilitate the use of output peripherals 1634 such as printers, audio devices, camera devices, and so on, such as a sound card and/or onboard audio processing capability.

One or more graphics interface(s) 1636 (also commonly referred to as a graphics processing unit (GPU)) provide graphics and video signals between the computer 1602 and external display(s) 1638 (e.g., LCD, plasma) and/or onboard displays 1640 (e.g., for portable computer). The graphics interface(s) 1636 can also be manufactured as part of the computer system board.

The computer 1602 can operate in a networked environment (e.g., IP-based) using logical connections via a wired/wireless communications subsystem 1642 to one or more networks and/or other computers. The other computers can include workstations, servers, routers, personal computers, microprocessor-based entertainment appliances, peer devices or other common network nodes, and typically include many or all of the elements described relative to the computer 1602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1602 connects to the network via a wired/wireless communication subsystem 1642 (e.g., a network interface adapter, onboard transceiver subsystem, etc.) to communicate with wired/wireless networks, wired/wireless printers, wired/wireless input devices 1644, and so on. The computer 1602 can include a modem or other means for establishing communications over the network. In a networked environment, programs and data relative to the computer 1602 can be stored in the remote memory/storage device, as is associated with a distributed system. It will be appreciated that the network connections shown are exemplary and other means of establishing a communications link between the computers can be used.

The computer 1602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented data processing system having computer readable media that store executable instructions executed by a processor, comprising:
a structure generator component that generates a summary structure based on documents, the summary structure includes nodes for labels in the documents and path information to positions of the nodes in the documents;
a table generator component that generates a table definition based on the summary structure and creates a table according to the table definition, where each node of the summary structure maps to one or more columns of the table and where one column of the table contains a document-position column that identifies one position in a document such that for each row, a document-position, summary structure, and schema structure include suitable information to derive location of all populated elements of the row in the document; and
a storage component that maps the nodes and path information of documents into the table according to the table definition.

2. The system of claim 1, wherein the document-position column is an ordpath.

3. The system of claim 1, wherein the structure generator component generates the summary structure using schema information about the documents.

4. The system of claim 1, wherein the summary generator component annotates the summary structure to indicate instances of child nodes relative to a parent.

5. The system of claim 1, wherein the table includes columns for at least one of a document identifier, the path information, element column for each node of the summary structure, text element column for each element node that has text content, or attribute column for each attribute node of the summary structure.

6. The system of claim 1, wherein the storage component translates each of the documents into rows of the table.

7. The system of claim 1, wherein the summary structure includes exception nodes that track order of the nodes in the documents.

8. The system of claim 1, further comprising a query component that translates a query over XML documents into a relational algebra query over the columns of the table.

9. The system of claim 8, wherein the query is expressed in XPath.

10. The system of claim 8, wherein the query component rewrites the relational algebra query based on table variables assigned to nodes of the summary structure.

11. The system of claim 10, wherein the query component optimizes the query by eliminating join operators based on at least one of the table variables, predicates, or summary structure used in the query.

12. The system of claim 1, wherein the structure generator component, table generator component, and storage component are part of a mid-tier component that stores tables and executes queries.

13. The system of claim 1, wherein the structure generator component, table generator component, and storage component create an index over a document-valued column of a table.

14. The system of claim 1, wherein the structure generator component, table generator component, and storage component are a primary storage system for a document-valued column.

15. A computer-implemented data processing method executable via a processor, comprising:
receiving document of document elements for mapping into a table;
creating a summary structure of nodes of the document and a table definition for the table based on the summary structure;
mapping each node of the summary structure to one or more columns in the table according to an order of document nodes in the summary structure; and
storing one document node per row in the table.

16. The method of claim 15, further comprising annotating the summary structure with path information that identifies an exact position of a node in the summary structure.

17. The method of claim 15, further comprising creating at least one column in the table for each node in the summary structure.

18. The method of claim 15, further comprising translating a query directed to the documents into a relational algebra query and optimizing the relational algebra query based on table variables assigned to nodes of the summary structure.

19. The method of claim 18, further comprising removing join operators in the relational algebra query based on rewriting rules.

20. The method of claim 15, further comprising storing instances of a child node in a same row as an associated parent node.

21. A computer-implemented data processing method executable via a processor, comprising:
receiving documents for mapping into a table;
creating a summary structure of nodes of the documents;
annotating the summary structure with path information to each of the nodes;
creating a table definition for the table based on the summary structure;
creating the table based on the table definition;
mapping each node of the summary structure to one or more columns in the table according to an order of document nodes in the summary structure; and
storing documents nodes one node per row in the table.

22. The method of claim 21, further comprising enforcing order among sibling nodes in the summary structure based on an exception node.

23. The method of claim 21, further comprising storing child document nodes that are non-collection elements in a same row in the table.

24. The method of claim 21, further comprising storing child document nodes that are collection elements in different rows in the table.

25. The method of claim 21, further comprising storing child document nodes that are exception nodes in separate rows of the table.
